(19) United States
(12) Patent Application Publication
(10) Pub. No.: US 2010/0076585 A1
(43) Pub. Date: Mar. 25, 2010

(54) METHOD FOR THE PRODUCTION OF A LABEL, AND DEVICE FOR CARRYING OUT SAID METHOD

(75) Inventors: Boris Mayer, Bonn (DE); Thomas Ogilvie, Bonn (DE)

Correspondence Address: International IP Law Group, P.O. BOX 691927, HOUSTON, TX, 77269-1927, US

(73) Assignee: Deutsche Post AG, Bonn (DE)

(21) Appl. No.: 12/447,262

(22) PCT Filed: Oct. 24, 2007
(86) PCT No.: PCT/EP2007/009229

§ 371 Date: Apr. 27, 2009

(30) Foreign Application Priority Data
Oct. 27, 2006 (EP) 06022480.5

(51) Int. Cl. G06F 17/50; G06F 15/16

(52) U.S. Cl. 700/117; 709/203

(57) ABSTRACT

There is provided a method and system for the production of a label that can be applied onto a mailpiece. An exemplary method comprises transmitting a code to a user via a first transmission route, the code being transmitted to a server by an operating unit located in the sphere of influence of the user and executing a checking step on the server to check the code. The exemplary method also comprises influencing the production of the label as a function of a result of the checking step.

### CROSS REFERENCE TO RELATED APPLICATIONS

Pursuant to 35 U.S.C. §371, this application is the United States National Stage Application of International Patent Application No. PCT/EP2007/009229, filed on Oct. 24, 2007, the contents of which are incorporated by reference as if set forth in their entirety herein, which claims priority to European (EP) Patent Application No. 06022480.5, filed Oct. 27, 2006, the contents of which are incorporated by reference as if set forth in their entirety herein.

### BACKGROUND

It is a known procedure to add labels to mailpieces—especially to merchandise shipments—in order to facilitate returns.

### SUMMARY OF THE INVENTION

There is a need to put forward a method for the production of a label that can be applied onto a mailpiece, whereby said method allows the production of the label as a tailor-made solution.

Therefore, an exemplary embodiment of the present invention may provide a method for the production of a label or to configure a device for the production of a label in such a way that a high level of operating convenience for a user is associated with a high degree of protection against manipulation.

Thus, a method for the production of a label according to an exemplary embodiment of the present invention is carried out in such a way that, via a first transmission route, a code (e.g. alphanumeric) is transmitted to a user and that the code is transmitted to a server by an operating unit located in the sphere of influence of the user. Here, the code can be generated either by a shipping service provider or by a third party (e.g. mail-order company), whereby the code is defined either by the shipping service provider or by a third party.

An exemplary embodiment of the present invention provides for a multi-step production of a label. This multi-step production may be characterized in that, via a first transmission route, a code is transmitted to a user, that the code is transmitted to a server by an operating unit located in the sphere of influence of the user and that the server executes a checking step in order to check the code and, as a function of the result of the checking step, influences the production of the label.

The code can be transmitted to the user in various ways.

A refinement of an exemplary embodiment of the present invention provides for the code or for a constituent of the code to be transmitted to the user via different transmission routes.

A transmission to the user may also be carried out when the code or a constituent of the code is transmitted to an operating unit located in the sphere of influence of the user.

This is the case, for example, with a transmission to a computer or to a mobile user terminal device such as a mobile telephone.

A refinement of the method, of the computer program product and of the device according to an exemplary embodiment of the present invention is characterized in that the code is added to a mailpiece addressed to the user.

The method, the computer program product and the device according to an exemplary embodiment of the present invention provides for the code to be transmitted to the user electronically.

A refinement of the method, of the computer program product and of the device according to an exemplary embodiment of the present invention is characterized in that the code is transmitted to the user when a given event occurs.

The method, the computer program product and the device according to an exemplary embodiment of the present invention provides for the code to be transmitted during or before the occurrence of a shipping event.

A refinement of the method, of the computer program product and of the device according to an exemplary embodiment of the present invention is characterized in that the code is transmitted in response to a request of a user.

The method, the computer program product and the device according to an exemplary embodiment of the present invention provides for the operating unit to be a computer.

A refinement of the method, of the computer program product and of the device according to an exemplary embodiment of the present invention is characterized in that the checking step comprises a validity check of the code.

The method, the computer program product and the device according to an exemplary embodiment of the present invention provides for the checking step to comprise a validity check of the code.

A refinement of the method, of the computer program product and of the device according to an exemplary embodiment of the present invention is characterized in that, taking the code into account, a recipient address is automatically ascertained for the mailpiece.

The method, the computer program product and the device according to an exemplary embodiment of the present invention provides that, taking the code into account, a sender address is automatically ascertained for the mailpiece.

Online franking solutions are advantageous for purposes of improving return logistics processes, whereby it is possible to lower process costs as well as to optimize information transparency.

As used herein, the term “return logistics processes” refers to logistics processes for handling returns.

An exemplary embodiment of the present invention comprises the refinement of a logistics system as a return logistics system as well as the configuration of a logistics system with handling procedures for handling returns.

An exemplary embodiment of the present invention comprises a logistics system for conveying a mailpiece along a transport route within a postal distribution network, whereby the transport route comprises several nodes of the postal distribution network, especially a node that corresponds to a delivery point.

If applicable, the transport route also comprises one or more nodes that each correspond to a sorting point.

Within the scope of an exemplary embodiment of the present invention, the term “logistics system” is to be understood in its broadest sense. In particular, it comprises systems containing the means and devices to carry out the transport of mailpieces from an origination site to a delivery point along a transport route within a postal distribution network.

The origination site is, for example, a storage site or drop-off site of the object that is to be transported.

The delivery point is preferably selected by the party ordering the transport or else the delivery point is automatically prescribed to the ordering party. In case of a return, this is, for example, a warehouse of a mail-order company or manufacturer.

An exemplary embodiment of the present invention also comprises a refinement of the method for the production of the label that can be applied onto the mailpiece within the scope of a transportation method for the mailpiece.

A refinement of the method, of the computer program product and of the device according to an exemplary embodiment of the present invention is characterized in that, taking the code into account, additional information such as, for example, the type, scope or condition of a product (merchandise) returned with the mailpiece is ascertained and applied onto the return label and/or transmitted to a shipping information system.

Moreover, an exemplary embodiment of the present invention comprises a system that is suitable to execute the presented method steps. For this purpose, individual or several of the method features and/or device features presented in this application are employed.

Furthermore, a computer program product according to an exemplary embodiment of the present invention is provided that contains a computer program for executing a method of the above-mentioned type.

Advantages, special features and practical refinements of exemplary embodiments of the present invention are described below making reference to the figures.

### BRIEF DESCRIPTION OF THE DRAWINGS

The figures show the following:

FIG. 1 is a block diagram of a network node 10 according to an exemplary embodiment of the present invention with connected Internet shipping information systems and provider servers 100₁, . . . , 100ₘ for the execution of service programs; and

FIG. 2 is a block diagram useful in explaining the integration of document production into a system according to an exemplary embodiment of the present invention.

### DETAILED DESCRIPTION OF SPECIFIC EMBODIMENTS

The invention relates to a method for the production of a label, whereby the label is made available to an operating unit.

The invention also relates to a device for carrying out the method.

The use of an exemplary embodiment of the present invention in systems for the production of labels or other print-outs for placement onto mailpieces or on other merchandise to be transported is especially advantageous.

In this case, it is especially advantageous for address data and/or franking-relevant data to constitute dynamic contents as set forth in the invention.

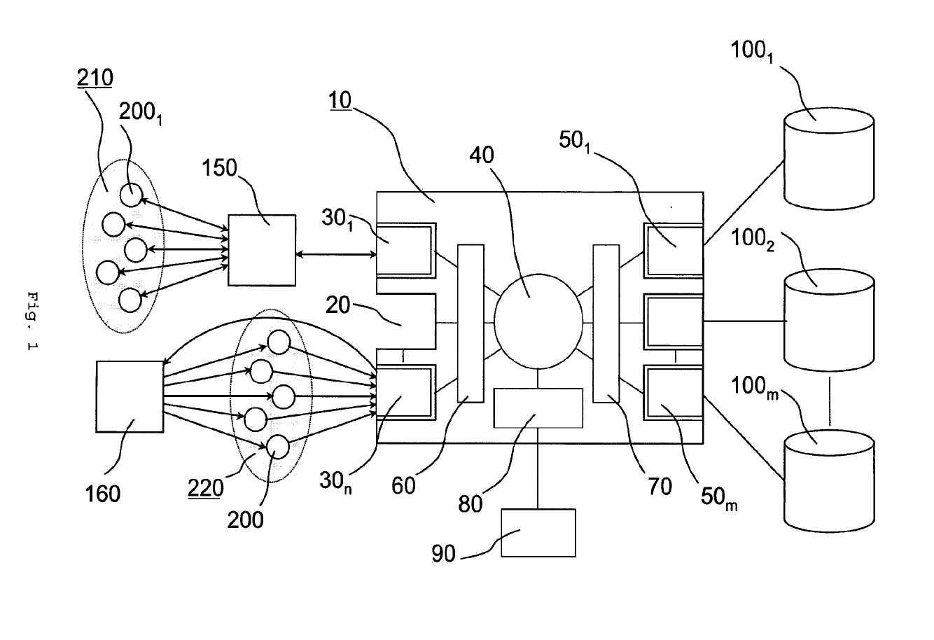

FIG. 1 shows a schematic depiction of a network node 10 according to an exemplary embodiment of the present invention, with connected Internet shipping information systems and provider servers 100₁, . . . , 100ₘ for the execution of service programs.

The depicted Internet shipping information systems are preferably servers according to an exemplary embodiment of the present invention. These are information systems for processing shipping information. Since these systems are preferably Internet-based, the term Internet shipping information systems was selected to explain them. The person skilled in the art can, of course, also use the presented special features in shipping information systems that are not Internet-based. However, preference is given to Internet-based systems.

A provider server or—which is even preferable—several provider servers each comprise at least one listing tool or, for example, a merchandise management system or, in more general terms, a storage unit, to provide information about merchandise sent to the user as a mailpiece.

The term “listing tool” comprises all services that make it possible to display and/or forward product information.

It is advantageous for the data to be automatically transferred to the franking service by the shipping information system and/or by a listing tool.

In a preferred exemplary embodiment of the invention, the forwarding can take place to a data processing unit, especially a computer, that is configured to process service requests.

Additional input possibilities are, for example, written recording and later digitalization, for example, by a service provider unit.

It is advantageous that users can also already indicate the shipping product and the applicable shipping costs. As an alternative, this specification can also be effectuated directly by the shipping information system in an automated procedure.

This applies especially in the context of this specification process.

For this purpose, the possibility exists to select the shipping services that are to be offered by the seller. This selection field is optimally dynamic and connected to the product/price system of a shipping service provider via an interface, so that the correct price portfolio and product portfolio are always displayed, or the portfolio authorized for the provider (e.g. mail-order company) is automatically displayed to the user (e.g. mail-order customer) with or without price information, whereby this presentation can be on display media (e.g. Internet pages) of a shipping service provider or of a third party (e.g. mail-order company).

The pre-selection of one or more shipping services by a seller (e.g. mail-order company) also means that, in the input systems, the following condition is established: if a return label is requested by a user via a code, on the basis of the data associated by the code, the following is automatically transferred:

sender data and/or
recipient data as well as
information for the specification of the shipping product selected.

Preferably, the data is transferred to the franking service via an interface in the form of a specified parameter set or in the form of a data record defined according to a specific convention.

The object—below also referred to as the article—is displayed in the described shipping information system on the basis of the specification data that contains the shipping information and shipping conditions.

Preferably, the display is made as a function of a code. This code also comprises the dependence of a constituent of the code or of a value ascertained by an evaluation—especially by the checking step on the basis of the code.

The code was advantageously transmitted to the user in advance so that the user or an operating unit associated with the user can transmit the code to the server.

The transmission of the code takes place irrespective of the way in which the code was transmitted to the user.

Especially preferred method steps for executing the method will be presented below.

In a first method step, a code—for example, an alphanumeric character string—is transmitted to the user—preferably a customer of a mail-order company.

The transmission can be associated with the shipment of merchandise to the customer, but can likewise also take place independently and/or in addition to this (e.g. upon request of the user).

In the case of a transmission together with the merchandise, this is done, for example, by a package sticker, by an information carrier sent along with the package or in a letter accompanying the package.

Furthermore, it is possible for the article to be directly provided with a code.

As an alternative or in addition to this, the transmission can be made electronically—for example, via an e-mail, an SMS or as a download.

In an exemplary embodiment of the present invention, the electronic transmission is automated—for instance, at the time of a shipping event such as the sending of the mailpiece addressed to the user or at the time of the delivery of the mailpiece to the user.

In order to distribute the codes, a specific set of codes is made available to the mail-order company or else the codes are generated by the mail-order company according to defined conventions.

Advantageously, suitable information parameters are associated with the code before it is transmitted to the user via the first transmission route. Advantageously, these information parameters are stored in the ordering system by the mail-order company as the sender of the codes.

The associated information includes, for example,
a. address data of the recipient,
b. address data of the sender,
c. shopping cart number,
d. if applicable, the number of articles contained in the shipment,
e. if applicable, the type (designation) of the articles contained in the shipment or of a specific article contained in the shipment.

If the customer would like to return a shipment, he or she goes to the Internet site of the mail-order company or to a separate platform (e.g. an independent return platform that is operated by the shipping service provider) and loads a specific page on which codes can be entered in order to produce return labels.

Optionally, this can also be done by telephone, whereby the return label would then have to be sent by mail.

The customer then enters the appropriate code into the prescribed input mask.

If a customer has ordered several articles, each of which contains a code (see 1d), it should be possible to enter several codes and to select whether one or more return labels are needed.

The sender address of the customer and/or the address of the mail-order company are loaded as the destination address from the data memory of the mail-order company by the entered code and this information is transferred in the form of a parameter set to the franking solution of the shipping service provider.

This can optionally be augmented with other information such as the e-mail address of the customer.

On the basis of the entered codes, thanks to a data reconciliation with the article data, the merchandise to be returned is already known to the mail-order company, as a result of which the return management can be optimized.

On the basis of the received parameters, the shipping service provider provides the return label with the address specification. This can be done, for example:
a) directly by an e-mail sent to the customer (if—as described in 6a—e-mail data was provided),
b) as a file (e.g. PDF) via the described interface directly on the page of the mail-order company, where the customer can then retrieve the return label,
c) purely as a data record, whereby the production of the label is only initiated by a program that is integrated into the site of the mail-order company,
d) sending as a physical label that is produced by the shipping service provider and delivered to the buyer.

The customer prints the delivered return label and drops off the shipment at a shipping service provider. In this process, the customer can optionally also arrange for the merchandise to be picked up.

The billing for the return service is handled between the mail-order company and the shipping service provider on the basis of the utilized codes.

The label can have different appearances.

The label is preferably configured in such a manner that it allows an identification and/or control of the mailpieces and, if applicable, also the coordination of a warehouse location.

Advantageously, the labels are scratch-proof and impact-proof as well as temperature-resistant.

Examples of such labels are:

barcode labels,

Electronic Article Surveillance (EAS) labels,

labels for merchandise tracking,

intelligent labels,

inventory labels,

pallet labels,

security labels,

thermo labels,

thermo-transfer labels,

transponder labels.

Encoded information is inserted into the labels as control instruments for parcel logistics.

In particular, the labels can contain consecutive numbering—optionally with a check digit—other types of numbering or address information.

Especially extensive data volumes can be inserted into SmartLabels.

REID identification systems—“SmartLabels”—allow an optimization of the logistical processes.

Hence, they are a suitable means for influencing—including controlling—flexible distribution systems for the route-optimized delivery of the mailpieces.

The labels are preferably transmitted to the operating unit in the form of an intelligent document.

In a refinement of an exemplary embodiment of the present invention, an intelligent document is used comprising a program which, when a precondition has been met, can be executed by a program execution environment, said intelligent document containing contents that can be displayed by a display program. The intelligent document is characterized in that it contains a program module that is configured to create displayable information indicating the result of the checking step in order to check whether the precondition has been met within the intelligent document.

The method, the intelligent document and the device according to an exemplary embodiment of the present invention provides that the program execution environment is a component of the display program.

After the purchase of an article by a buyer—for example, at the end of an auction or in the form of a purchase at a fixed price from a mail-order company—the process of transacting the shipment begins, which is optimized by an exemplary embodiment of the present invention.

Preferably, the shipping and/or franking-relevant data is automatically transferred by the shipping information system or by the listing tools—that is to say, without any further action on the part of the seller—to the franking service via an interface.

It is advantageous for the data to be provided by the shipping information system and/or by the listing tool via the provider server.

On the basis of the shipping and/or franking-relevant data, the franking service produces the appropriate franking label and automatically transmits it via an interface to the seller.

This can be done, for example, in the following ways:
by e-mail to the seller,
via the described interface as a data record (e.g. PDF),
directly on the described shipping information systems or listing tools, via which the seller can then retrieve the shipping label,
purely as a data record, whereby the production of the label is only initiated by a program that is integrated into the shipping information system or into the listing tool, or
by sending it as a physical label that is produced by the shipping service provider and delivered to the buyer.

It is advantageous for the data to be transferred by the shipping information system and/or by the listing tool in the form of an automated service request to the franking service.

Moreover, it is advantageous for the service request to be transferred in the form of a parameter set and/or a specific data syntax.

It is advantageous for the service request to be transformed in an area of the provider server of the shipping service provider.

It is also practical to for address data to be transmitted to the franking service.

It is advantageous for a product specification to be transmitted to the franking service.

The billing for the shipping service can be done in various ways:

The shipping service provider bills the seller for the service provided (prerequisite: banking particulars are stored at the shipping service provider—e.g. the customer is a customer with a contract—and the authentication of the customer is made through an identifier in the parameter set displayed).

The shipping information system or the operator of the listing tool bills the seller for the shipping service. In this case, the shipping service provider transfers information about the shipping services that were utilized by a seller to the shipping information system operator or to the operator of the listing tool, and subsequently, said shipping service provider bills the shipping information system or the operator of the listing tool for the shipping services utilized by N (natural number) sellers.

In a preferred exemplary embodiment of the invention, the buyer sends a bank transfer to the seller as payment for the purchased article as well as for the shipping costs. Within the scope of this bank transfer process, the shipping cost portion (for example, identified on the basis of the contents of the memo line) is automatically subtracted and paid to the shipping service provider. Only once the money has been received by the shipping service provider is the shipping label—automatically as described—given to the seller.

It is advantageous that, when the article is dropped off and/or when the shipping data is transmitted to the franking service, the postage amount is automatically deducted from an account of the seller.

Optionally, the seller can already have prepaid the postage amount the process step, or he or she can have given permission for the postage amount to be automatically deducted from an account of the seller after the article has been sold and after the shipping data has been supplied to the franking service.

As an alternative, it is possible that, after the article has been sold and after the shipping data has been transmitted to the franking service, the postage amount is automatically deducted from an account of the buyer.

In another advantageous exemplary embodiment of the invention, the seller can select a (first) electronic parcel deposit box facility (package station) as the modality for the drop-off.

Moreover, it is advantageous to integrate an exemplary embodiment of the present invention into a logistics system in such a way that the recipient can select a (second) package station as the delivery address.

The selection of a package station as the delivery address is preferably made independently of the selection of the drop-off modality. In particular, it is possible and advantageous for a package station to be selected as the delivery address even if a different drop-off modality was selected for the drop-off, for example, the package was picked up.

An exemplary embodiment of the present invention is suitable for transporting the articles over any desired distances, including the worldwide transport of the articles.

However, it is also possible to use an exemplary embodiment of the present invention to provide a local selling device—for example, as an automated store.

This is done, for example, by an exemplary embodiment of the present invention in which the first package station and the second package station are identical.

Moreover, it is advantageous for the payment amount for the shipping to be ascertained automatically.

A preferred exemplary embodiment of the invention may be characterized in that the amount for the shipping is ascertained as a function of the delivery address and/or of the sender address.

The following combination of these features is especially advantageous:

If the seller has selected an electronic package station or another specific type of address as the drop-off modality or if the buyer has selected an electronic package station or another specific type of address as the delivery address, then the amount for the shipping is automatically ascertained as a function of the drop-off address and/or sender address.

According to an exemplary embodiment of the present invention, the possibility also exists that, if the buyer desires delivery to the electronic parcel deposit box facility—referred to below as the package station—but if he or she is not a package station customer, then the data present in the shipping information system (e.g. e-mail address) is used or else supplementary data (e.g. mobile phone number) is requested one time so that the shipment can also be delivered at a package station.

In this case, like with the existing package station process for registered customers, the buyer would receive a notification containing a transaction code with which the shipment can be retrieved at the package station.

In an especially advantageous case, the payment for the merchandise is held in escrow by an electronic escrow unit, especially by a payment provider, by the shipping information system or by the listing tool until the merchandise has been delivered to the buyer, whereby the individual steps for this could look as shown below and, at the same time, they include an automation (push function) for tracking and tracing (T&T):

The information of the identifier (e.g. barcode) applied onto the shipping label is also stored as a data record via an interface in the application for the management of auctions (on the buyer side as well as on the seller side) and transmitted to the payment provider.

At regular intervals, this application automatically submits a query to a T&T database of the shipping service provider to ascertain whether there is a new tracking event for the Identcode in question.

As an alternative, after the identifier that was created by the method described above has been delivered to and printed by the seller, said identifier is transmitted to and “flagged” in the T&T database, so that whenever a new T&T event is present, it is pro-actively transmitted to the application of the auction house/shipping information system.

If a new tracking event is present, this new status is automatically made visible to the seller and to the buyer in the application.

A tracking event is defined as the acquisition and/or transmission of information about a change in a conveying status of a shipment, for example, its pick-up or delivery.

As soon as the shipment has been delivered (that is to say, tracking event: shipment delivered), the payment provider is also notified of this so that only then is the money released to the seller.

In another case, this can be a COD payment, i.e. immediately after the end of the auction, the buyer can select “COD” as the payment option. In this case, the seller immediately receives the shipping label. The process is otherwise identical, except that the COD amount is transferred from the logistics provider to the payment provider, but the latter already releases the money for the seller with the delivery scan.

After the end of the auction, the seller is provided with a link via which he or she can download the produced and paid label—depending on the configuration, this is the shipping label and/or the franking label—with a click of the mouse (e.g. as a PDF or in the form of an HTML page, whereby the address data is taken over automatically and the preselected product and the associated payment are also taken into account).

As an alternative, the seller receives the label as a file or receives a code such that he or she can pick up the label at a sales point (e.g. a package station). This process optimizes the transaction work involved in the shipping transaction when articles are sold using a shipping information system, since the readied and paid shipping label can be made available immediately after the auction, without any further transaction work, and it only has to be printed out.

It is especially advantageous to integrate tracking & tracing. This is advantageously effectuated by an electronic system for monitoring the shipment, whereby the term tracking refers to ascertaining the current status of a shipment. The term tracing refers to the fact that the precise course of the shipment (especially the transport route of the shipment) with all of the important events can be reconstructed retroactively.

An especially preferred exemplary embodiment of the invention will be explained on the basis of the embodiment a network node 10, which will be referred to below as a transformation node.

The transformation node 10 is connected to several Internet shipping information systems via the Internet. By way of an example, FIG. 1 shows connections to two Internet shipping information systems that are set up in different configurations.

In one of the cases shown, the transformation node 10 is connected to a shipping information system server 150 of an Internet shipping information system which users of the shipping information system access via their user computers 200. The group of user computers 200 of the marketplace users is designated with reference numeral 210 in FIG. 1. A direct connection does not exist between the user computers 200 and the transformation node 10, so that the data exchange between the user computers 200 and the transformation node 10 takes place via the shipping information system server 150. Such an Internet shipping information system is referred to below as a transit shipping information system, and the shipping information system server 150 of such an Internet shipping information system is referred to as a consolidator source.

In the other case shown, the user computers 200 are connected to the transformation node 10 as well as to the shipping information system server 160, so that a data exchange can take place directly between the computers 200 and the transformation node 10. An Internet shipping information system configured in this manner is referred to below as an area shipping information system, while the shipping information system server 160 of such an Internet shipping information system is referred to as a dissemination source. In this case, the group of user computers 200—the marketplace users—is marked with the reference numeral 220.

In the case of the transit shipping information system and in case of the area shipping information system, the Internet shipping information system is accessed via the Internet on a website of the Internet shipping information system that is provided by the shipping information system server 150, 160 and that website is shown on a display means of the user computers 200 with a browser program that is executed in the user computers 200.

In an advantageous exemplary embodiment of the invention, the transformation node 10 contains external connectors 30 that, in the case of the transit shipping information system, are connected to the consolidator source 150 and that, in the case of the area shipping information system, are connected to the user computers 200 via a communication network, preferably the Internet. The external connectors 30₁, . . . , 30ₙ are used in connector slots 20 of the transformation node 10.

Within the transformation node 10, there is a connection between the external connectors 30₁, . . . , 30ₙ and an authorization and authentication unit 60 which, in turn, is connected to the transformation unit 40. The authorization and authentication unit 60 can be bridged for purposes of a direct data transmission between the internal connectors 50₁, . . . , 50ₘ and the transformation unit 40.

The transformation unit 40 is connected to a checking unit 70 which, in turn, is connected to internal connectors 50₁, . . . , 50ₘ. Here, too, a direct connection can be created between the transformation unit 40 and the internal connectors 50₁, . . . , 50ₘ, in which the checking unit 70 is bridged. The internal connectors 50₁, . . . , 50ₘ are likewise plugged into connector slots of the transformation node 10 and they connect the transformation node 10 to servers 100₁, . . . , 100ₘ on which service programs are run in order to perform Internet services.

Moreover, the transformation node 10 comprises a controlling and reporting unit 80 for administering the transformation node 10 and for logging purposes.

The transformation node 10 can be configured as hardware or as software. In an advantageous exemplary embodiment of the invention, it is realized in the form of several software modules that are executed in an Internet server.

Internet services are offered to the users of an Internet shipping information system; these services are made available by a service provider that can be independent of the shipping information system operator. Service programs for the execution of the Internet services are made available on at least one provider server 100₁, . . . , 100ₘ that is operated by the service provider. As far as the Internet services are concerned, in an advantageous application of an exemplary embodiment of the present invention that will be described below, these are franking and logistics services that allow, for example, the generation of electronic postage indicia, the production of address labels for sending mailpieces or shipment tracking of mailpieces and that are offered by a logistics service provider.

The request for the Internet services is initiated indirectly or directly on a website of the Internet shipping information system, for example, by actuating a button located on the website. Here, an exemplary embodiment of the present invention makes it possible for an Internet service not to be requested on a website of the service provider but rather directly on the website of the Internet shipping information system. In particular, web pages that might be displayed as a processing result or partial processing result when the service is performed can easily be adapted to the appearance of the web pages of the Internet shipping information system by the transformation node 10.

The generation of a service request is associated with the calling of the Internet services on the website of the Internet shipping information system, said service request containing especially information about the execution of the Internet service. This information is, for example, user data of the shipping information system user who can enter this information into a dialog field of the website, or else it can be stored in a database of the shipping information system operator. Moreover, the service request contains identification data of the Internet shipping information system and comprises at least an instruction that makes it possible for the transformation node 10 to identify the requested Internet service. This instruction can be implicitly contained in the service request. Thus, for instance, it can be provided that the requested Internet service or the provider server 100₁, . . . , 100ₘ for executing the Internet service is identified in the transformation node 10 on the basis of the type of information contained in the service request.

In the case of the area shipping information system, the service request is generated by scripts introduced into a web page and transmitted directly from the user computer 200 to the transformation node 10 via the Internet. In a transit shipping information system, the service request can be generated either by scripts in the web page of the Internet shipping information system and transmitted from the user computer 200 to the transformation node 10 via the consolidator source 150, or else, after the transmission of such a request from the user computer 200 to the consolidator source 150, said service request can be generated within the consolidator source 150.

By the same token, in the case of a transit shipping information system, it is possible for the service request to be generated by a script using the browser program of the user computer 200 and augmented by the consolidator source 150, for example, with identification information of the Internet shipping information system, with user data stored in a database of the consolidator source 150, or augmented with shipping information system profiles and/or user authorization profiles stored in the database of the consolidator source 150. In the case of an area shipping information system, such information is incorporated into the service request by a functionality of the scripts contained in the website of the Internet shipping information system.

Moreover, it is possible for a single service request to contain a request for several Internet services.

The connection between the transformation node 10 and an Internet shipping information system is made via an external connector 30₁, . . . , 30ₙ that is individually adapted to the Internet shipping information system. In the external connectors 30₁, . . . , 30ₙ, especially format changes are made to the service request and to the processing results ascertained in the provider servers and described below.

These are static format changes that are made independently of the content of the service request. Examples of such format changes are conversions of protocol formats such as, for example, a conversion of EDIFACT documents into XML documents and vice versa, as well as changes to character set encoding and changes to field designations and field sequences in the service request. Thus, for example, data records can be converted such as user data, whose format is aimed at the requirements of the shipping information system server 150, 160, such as, for example, a certain database format used in the shipping information system server 150, 160.

Owing to the possibility of changing the format in the external connectors 30₁, . . . , 30ₙ, it can be ensured that changes relating to the communication between the transformation node 10 and an Internet shipping information system have no effects on the internal functionality of the transformation node 10 and no effect on the configuration of the provider servers 100₁, . . . , 100ₘ or on the service programs executed on the provider servers 100₁, . . . , 100ₘ.

In order to interconnect a plurality of Internet shipping information systems, the transformation node 10 has a plurality of connector slots 20 to receive external connectors 30₁, . . . , 30ₙ. Here it is possible to plug and unplug external connectors 30₁, . . . , 30ₙ during the ongoing operation of the transformation node, thus ensuring interruption-free operation of the transformation node 10, even when an Internet shipping information system is added or eliminated. In the case of changes that are made to an external connector 30₁, . . . , 30ₙ, such a connector can likewise be unplugged, adapted and plugged in again in the activated state of the transformation node 10, so that here as well, no interruption in the operation of the transformation node 10 is necessary.

A service request is received by the transformation node 10 at the external connector 30₁, . . . , 30ₙ that is associated with the corresponding Internet shipping information system and, if applicable, a format change of the above-mentioned type is made. There is fundamentally no difference in terms of the various types of shipping information systems.

An external connector 30₁, . . . , 30ₙ transfers the service request within the transformation node 10 to an authorization and authentication unit 60 which first carries out an authentication step to check whether Internet services of the service provider are fundamentally allowed to be utilized. Here, the authentication is carried out on the basis of the identity of the Internet shipping information system and/or on the basis of the identity of the shipping information system user.

The authentication is made on the basis of authentication information that is contained in the device request and whose authenticity is ensured by the use of cryptographic methods. Suitable cryptographic methods include, for example, digital signatures of the service request or a part thereof. Likewise, it is possible for contents of the service request to be encrypted using a key (asymmetrical encryption with certified keys) that is associated with the Internet shipping information system or with the shipping information system user, or else using a symmetrical key (symmetrical encryption with “pre-shared key”) that is exchanged ahead of time between the transformation node 10 and the Internet shipping information system or the shipping information system user.

If a successful authentication is not possible, this means that it is not an authentic service request of the user of a registered Internet shipping information system or else it means that, for other reasons, the shipping information system user is not authorized to utilize Internet services of the service provider. In this case, the authorization and authentication unit 60 generates an error message that is transmitted via the external connector 30₁, . . . , 30ₙ to the user computer 200. Moreover, logging of the service request can be provided by the controlling and reporting unit 80, which will be explained below.

After a successful authentication, the authorization and authentication unit 60 carries out an authentication step to ascertain the authorization of the shipping information system user to utilize the Internet services. This procedure checks which Internet services the shipping information system user is allowed to make use of and to what extent. This is likewise done on the basis of the identity of the Internet shipping information system and/or on the basis of the identity of the shipping information system user.

The authorization of an Internet shipping information system is carried out on the basis of a shipping information system authorization profile that is preferably stored in the authorization and authentication unit 60. The shipping information system authorization profile contains information about the extent to which Internet services can be utilized by users of the shipping information system, i.e. which functions within the Internet service can be performed by users of the shipping information system.

The authorization of a shipping information system user is preferably carried out on the basis of a user authorization profile in the service request, which is likewise cryptographically secured. The user authorization profile is preferably incorporated into the service request on the part of the Internet shipping information system by the shipping information system server 150, 160 or by a script that is embedded into the website of the Internet shipping information system, or else said user authorization profile is stored in the transformation node 10 in a database. The user authorization profile indicates the extent to which the user can make use of Internet services of the service provider. In this manner, the shipping information system operator can provide the user of the Internet shipping information system with different access rights to the Internet services of the service provider.

Functions that are available within the Internet service or the extent to which the Internet service can be utilized relate, for example, to various payment possibilities for making use of the Internet service, to the possibility to store data on the provider server 100₁, . . . , 100ₙ for re-use when the service is accessed again as well as to the size of the memory available for this purpose and to additional services that are offered within the scope of the Internet service.

In order to carry out the authorization, the authorization and authentication unit 60 checks on the basis of the shipping information system authorization profile and/or of the user authorization profile whether and to what extent the shipping information system user is authorized to utilize the Internet service or services being requested. If this checking procedure shows that the shipping information system user is not authorized to utilize the requested Internet service or services, then preferably an error message is generated and transmitted via the external connector 30₁, . . . , 30ₙ to the user computer 200 of the shipping information system user.

If the requested Internet services can only be identified at the time of an evaluation of the service request in the transformation unit 40, then the authorization and authentication unit 60 transmits the shipping information system authorization profile or the user authorization profile to the transformation unit 40. In this case as well, however, it can be checked within the authorization and authentication unit 60 whether the shipping information system user is at all authorized to utilize Internet services of the service provider, whereby an error message is generated and transmitted to the user computer 200 of the shipping information system user if this is not the case.

If several Internet services are being requested with the service request, the authorization and authentication procedure in the authorization and authentication unit 60 consists of a single sign-in of the shipping information system user for the various Internet services.

The transformation unit 40 receives the service request, optionally together with the ascertained authorization information, from the authorization and authentication unit 60. Depending on the content of the service request and optionally on the authorization information ascertained in the authorization and authentication unit 60, the service request is converted by the transformation unit 40. Since the conversion, in contrast to the static format change that is made in the external connectors 30₁, . . . , 30ₙ, is carried out as a function of the content of the service request, it is also referred to here as an intelligent conversion.

In the transformation unit 40, processes are carried out within the scope of the intelligent conversion that allow the service request to be forwarded to the applicable service program carried out on one of the provider servers 100₁, . . . , 100ₘ. If several Internet services are being requested with one service request, for each of the services, the service request or the applicable part thereof is forwarded to a provider server 100₁, . . . , 100ₘ in the manner described below.

In this process, the transformation unit carries out a so-called routing of the service request, i.e. depending on its content, the provider server 100₁, . . . , 100ₘ on which the service program is executed is ascertained in order to execute the requested Internet service, and the service request is addressed to this provider server 100₁, . . . , 100ₘ. Furthermore, additional intelligent conversions are carried out such as, for example, a change and augmentation of data contained in the service request.

The intelligent conversions can also be, for instance, corrections that arise after plausibility checks or after the application of parsing rules, i.e. of rules for the interpretation of the service request. If, for example, an Internet service for producing address labels recognizes post office box information in a data field that is intended for designating the street name, then this can be corrected by the transformation unit 40.

By the same token, within the scope of the intelligent conversion, it is possible to change service requests in such a way that, instead of the requested Internet service, a more up-to-date, improved or less expensive service is executed (for example, within the scope of a special campaign).

Moreover, in a preferred exemplary embodiment of the invention, so-called dynamic routing is provided in which the availability of the provider servers 100₁, . . . , 100ₘ is ascertained and the service request is addressed to a provider server 100₁, . . . , 100ₘ whose availability is ascertained. Moreover, it can be provided that the transformation unit 40 performs a so-called load balancing in which, in addition to the availability, also the load status of the server 100₁, . . . , 100ₘ is ascertained and the service request is transmitted to the provider server 100₁, . . . , 100ₘ having the lowest load.

After the service request has been processed in the transformation unit 40, it is transmitted directly or via a checking unit 70 to the internal connector 50₁, . . . , 50ₘ that is connected to the ascertained provider server 100₁, . . . , 100ₘ.

Moreover, in a preferred exemplary embodiment of the invention, it is provided here that, together with the service request, authentic additional information, for example, encrypted information, is transmitted from the transformation unit 40 to the provider server 100₁, . . . , 100ₘ. In this process, the additional information is decrypted in the provider server 100₁, . . . , 100ₘ with a key that is unambiguously associated with the transformation unit 40 or with the transformation node 10, in order to check whether the service request has come from the transformation node 10. In this exemplary embodiment of the invention, it is possible to dispense with an additional authorization and/or authentication of the marketplace user in the provider server 100₁, . . . , 100ₘ.

The internal connectors 50₁, . . . , 50ₘ are capable of carrying out static format changes to the service program call and are connected to the transformation node 10 via connector slots into which internal connectors 50₁, . . . , 50ₘ are plugged in during ongoing operation and from which internal connectors 50₁, . . . , 50ₘ can be unplugged during ongoing operation.

Due to the mode of operation of the internal connectors 50₁, . . . , 50ₘ, when the service programs to the provider servers 100₁, . . . , 100ₘ are adapted, all that is needed is an adaptation of the connectors 50₁, . . . , 50ₘ, but not an adaptation of the transformation unit 40. Moreover, such adaptations can also be made during ongoing operation of the transformation node 10 in that the involved internal connectors 50₁, . . . , 50ₘ are unplugged during the adaptation.

The service request is transmitted to the ascertained provider server 100₁, . . . , 100ₘ via the internal connectors 50₁, . . . , 50ₘ. This is preferably done via a network like the Internet or—if the transformation node 10 is operated by the service provider itself—via an internal data network of the service provider.

After the service request has been processed in the service program executed on the provider server 100₁, . . . , 100ₘ, i.e. after the service has been performed, the provider server 100₁, . . . , 100ₘ sends the processing result, i.e. the data ascertained in the provider server 100₁, . . . , 100ₘ during the execution of the Internet service or of the service program, back to the transformation node 10, where it is, in turn, received by the internal connector 50₁, . . . , 50ₘ.

After the receipt and after the execution of any format changes that might need to be made within the internal connector 50₁, . . . , 50ₘ, the processing result is transferred to the checking unit 70 where the processing result is formally checked. In this process, it is checked whether the processing result is complete and formally correct. With an eye towards the completeness, for example, in case of a request for a digital postage indicium by a shipping information system user, it is checked whether the processing result comprises an imprint or a print preview of the postage indicium. The criteria for the checking are stored for the processing results of the various provider servers 100₁, . . . , 100ₘ in a database of the transformation node 10.

If the processing result is either incomplete or incorrect, then instead of the processing result or in addition to the processing result, a notification in which the error is indicated is transmitted to the user computer 200 of the shipping information system user.

The checking unit 70 is also capable of checking the availability of the provider server 100₁, . . . , 100ₘ and of informing the transformation unit about the result so that, on the basis of the checking results, the transformation unit can effectuate the described dynamic routing of service requests.

The checked processing result is fed within the transformation node 10 either via the transformation unit 40 or, by circumventing the transformation unit 40, to the external connectors 30₁, . . . , 30ₙ that are connected to the Internet shipping information system from which the service request originally came.

Further processing of the processing result in the transformation unit 40 is needed if an intelligent processing of the processing result is to be undertaken in addition to the forwarding of the processing result to the user computer 200 of the shipping information system user or to the consolidator source 150.

Here, it can be provided, for example, that in case of an area shipping information system, in addition to the transmission of the processing result to the user computer 200 or instead of the transmission of the processing result to the user computer 200, a notification about the processing result or the utilization of the service is transmitted to the dissemination source 160. This notification is produced in the transformation unit. The subject of the notification can be, for example, information that a certain shipping information system user has utilized a certain Internet service. In this manner, the result of the service can also be transmitted from the dissemination source 160 to the user computer 200.

After the optional processing of the processing result by the transformation unit 40, this processing result is either fed via the authorization and authentication unit 60 or, by circumventing this unit, to the external connectors 30₁, . . . , 30ₘ that are connected to the Internet shipping information system in question.

In an advantageous exemplary embodiment of the invention, it is provided that the user authorization profile can be changed in the authorization and authentication unit 60 as a function of the processing result.

Thus, for example, it is possible to authorize expanded rights for shipping information system users who frequently utilize a certain Internet service within the scope of a “frequent user program”, whereby for this purpose, the authorization and authentication unit 60 ascertains the number of processing results transmitted to a given shipping information system user.

The external connector 30₁, . . . , 30ₘ makes the requisite format changes that correspond to the format change during the processing of the service request in the external connector 30₁, . . . , 30ₘ, or that is prescribed independently thereof. Furthermore, various format changes can be made to the processing result and to the notification to the dissemination source 160 determined on the basis of the processing result.

Moreover, within the scope of a conversion of the processing result in the transformation unit 40 or within the scope of the format change in the external connector 30₁, . . . , 30ₙ, it is possible to make graphic adaptations of the processing result so that it can be adapted to the appearance of the shipping information system. This can especially be done if the processing result is a website containing certain information.

Finally, the external connector 30₁, . . . , 30ₙ transmits the processing result to the computer 200 of the shipping information system user from which the service request comes, or else to the consolidator source 150 of a transit shipping information system and optionally also to the dissemination source 160 of an area shipping information system.

In order to administer and monitor the transformation node 10, a controlling and reporting unit 80 is provided that is operated by an administrator. One or more external data processing devices 90 can be connected to the controlling and reporting unit 80 for purposes of evaluating utilization data of the transformation node 10.

The controlling and reporting unit 80 can, on the one hand, define the rules for the format change in the external connectors 30₁, . . . , 30ₙ and in the internal connectors 50₁, . . . , 50ₘ, the rules for the authorization and authentication unit 60, the rules for the intelligent conversion in the transformation node 40, as well as the criteria for checking the processing results in the checking unit 70. On the other hand, the controlling and reporting unit 80 is capable of ascertaining the utilization of the transformation node 10 and of the connected provider servers 100₁, . . . , 100ₘ by the user of the Internet shipping information systems and to provide this in the form of access tables and statistics for evaluation and billing purposes. All of the administration and evaluation activities can also be carried out by the connected data processing devices 90.

Moreover, especially comparisons can be made between the point in time at which a service request is received in the transformation node 10 and the point in time at which the processing result is sent out by the transformation node 10, so that, in this manner, it is possible to ascertain a processing duration and to check compliance of availability commitments in individual cases as well as statistically. For this purpose, the necessary information for evaluation is transmitted from the transformation unit 40 to the controlling and reporting unit 80 and evaluated there or in the data processing devices 90.

A possible application scenario of an exemplary embodiment of the present invention relates to the provision of franking and logistics services that are made available by a logistics company, for users of a transaction portal in which merchandise is auctioned by a seller to a buyer within the scope of auctions. As a rule, the auctioned merchandise is sent by the seller to the buyer as a mailpiece.

Within the scope of an exemplary embodiment of the present invention, the following Internet services, for example, can be offered to the sellers who visit the transaction portal:
an Internet service for generating digital postage indicia that can be printed out by the seller using his or her user computer 200,
an Internet service for producing address labels for sending auctioned merchandise,
Internet services for ascertaining a product of the logistic company that is suitable for the shipment and for ascertaining postal codes or delivery locations such as, for example, package station locations,
an Internet service for tracking the shipment of the mailpieces sent.

In transacting an auction, a seller can, for example, initiate the franking of a mailpiece for shipment of the auctioned article directly on the website of the transaction portal.

For franking purposes, an Internet service for generating digital postage indicia can be used in which an imprint of a (e.g. cryptographically secured) digital postage indicium is generated in the provider server 100₁, . . . , 100ₘ and transmitted to the user computer 200 of the seller. The imprint can be, for example, a PDF document that can be printed out with a printer that is connected to the user computer 200.

Here, for example, there is no longer a need to provide information such as the sender and recipient address, the desired product and the printing medium for generating the postage indicium, which is normally needed to use the franking service, since this information is known within the transaction portal or can be derived from known information. Instead, this information is compiled in the transaction portal and transmitted in the service request to the transformation node 10. The transformation node 10 and especially the transformation unit 40 take over the intelligent conversion in such a way that certain process steps that otherwise have to be carried out when the franking service is utilized can be skipped. In this manner, the process for the seller is simplified and accelerated. Thus, for example, the information about the recipient of the mailpiece, i.e. about the buyer of the merchandise, can be obtained from data that was acquired before or during the auction and that can be automatically incorporated into the service request for utilizing the franking service. The information about the sender can likewise be provided by the Internet shipping information system and automatically incorporated into the service request.

Within the scope of the processing of the service request in the transformation node 10, it is possible to execute a format change of the service request, an authorization of the use of the franking service or of other services, the routing and an intelligent conversion as well as the forwarding of the service request to the provider server 100₁, . . . , 100ₘ in which the franking service is carried out.

Since a transaction portal is generally an area shipping information system, the processing result ascertained in the provider server 100₁, . . . , 100ₘ is transmitted from the transformation node 10 directly to the user computer 200 of the seller. In the checking unit 70 of the transformation node 10, for example, it can be checked whether the processing result ascertained in the provider server 100₁, . . . , 100ₘ during the execution of the franking service contains the imprint of the digital postage indicium.

Moreover, a notification about the execution of the franking service is generated and transmitted to the dissemination source 160 of the transaction portal. The latter can, for example, also serve to display information to the seller on the website of the transaction portal about the successful execution of the franking service.

Furthermore, it is possible to draw up access lists and statistics about the utilization of the franking and logistics services by users of the transaction portal.

Finally, the transformation node serves to check conditions for the provision of the services (“Service Level Agreement”, SLA) as agreed upon with the Internet shipping information system, and to report and document deviations. Important aspects in this context are, among others, the availability of the provider servers 100₁, . . . , 100ₘ (i.e. it must be possible to process requests) and the processing duration (i.e. processing results have to be made available within a certain period of time).

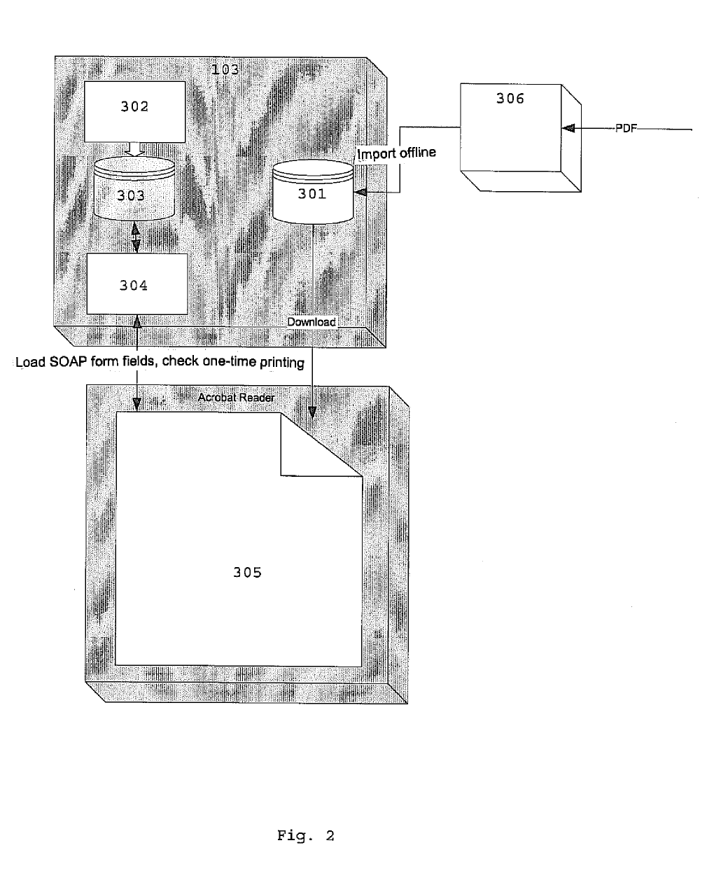

FIG. 2 shows a schematic depiction of the integration of label production into a system according to an exemplary embodiment of the present invention.

The depicted system comprises a server 103 that allows the transmission of displayable contents.

The displayable contents for the production of the label consist of static contents and dynamic contents.

In the exemplary embodiment shown, the static contents are incorporated as PDF templates into a document that is to be generated.

Dynamic contents are incorporated by a suitable server, preferably by a POP web server 302, into a document data record 303. These dynamic contents can optionally be augmented by additional contents. These additional contents can be static contents or dynamic contents, depending on the intended use. The addition of dynamic contents is preferred since this allows identifiable documents to be created in a simple and practical manner.

In an especially preferred exemplary embodiment of the invention, this is done in that the dynamic contents are linked to licensing information 304.

Below, an exemplary embodiment of the present invention will be explained on the basis of the production of labels. The labels are, for example, address labels and/or franking labels. Such labels are especially well-suited for controlling logistical procedures such as, for instance, “tracking and tracing” as well as for controlling logistical processes such as, for instance, sorting mailpieces.

For this purpose, the labels are preferably configured to be machine-readable.

The label that is to be printed is provided with a PDF envelope. A transmission of the licensing information 304 is made possible inside this envelope, within the scope of communication with the server 103.

Consequently, by incorporating the licensing information 304, a licensing service is provided for printing the PDF envelope. The license service controls the printing of the document contained in the PDF envelope.

Since intelligent documents are provided in this manner, they are described below as iPDFs.

The following process steps are carried out here:

During (or possibly in advance of) the generation of the PDF, each PDF is linked to an unambiguous document ID that cannot be guessed by the user by trial-and-error.

This document ID is embedded, on the one hand, into the iPDF and, on the other hand, also into a table of a database of the application.

In order to prevent multiple print-outs, mechanisms are built into the PDFs delivered to the user and, prior to every printing operation, they check whether the document has already been printed before.

In order to check this, a connection with a service provided by the application has to be made from the Acrobat Reader and this checking procedure is carried out via this application.

If it is ascertained that the user has authorization to produce a label, then data for the generation of the intelligent document is provided.

This authorization is present in a return system if, on the basis of at least one predefinable criterion, it is ascertained that the user has authorization to send the merchandise back to the mail-order company.

In a subsequent process step, the data for the generation of the intelligent document—for example, as a PDF—is made available.

At this point, the server application generates a data record for each PDF to be generated on the basis of the shopping cart and all of the information needed for the generation is already completely resolved in this data record.

An advantageous data record for checking the one-time printing is depicted below.

### Document Data Record

| Field name | Type | Description |
|---|---|---|
| Document ID | ID (PK) | ID of the document. This ID is also |
| | | embedded in the delivered iPDF |
| | | envelope. |
| CreateDate | TimeStamp | Time stamp of the generation of |
| | | the PDF |
| ValidUntil | TimeStamp | Valid until |
| Printed | TimeStamp | Was the PDF already printed? |
| DownloadedFirst | TimeStamp | When was the PDF downloaded for |
| | | the first time? |
| DownloadedLast | TimeStamp | When was the PDF downloaded for |
| | | the last time? |
| DownloadCounter | Integer | How often was the PDF downloaded? |
| FormData | Blob | The form data of the PDF. |
| | | This includes: |
| | | Sender address and recipient address. |
| | | Codes for barcodes. |
| | | Product services (e.g. green parcel) |
| | | Information about selected additional |
| | | services, insofar as they relate to the |
| | | imprint. Information relating to the type |
| | | and/or scope of the merchandise to be |
| | | sent back. |

FormData contains all of the already resolved data in a structured form (XML) relating to the data to be imprinted. Thus, for example, the already generated shipment identifiers, routing codes and optionally additional information (also prices, although this is currently not provided for) are already given as numbers or characters strings. A subsequent calculation of such data is not provided for since this might possibly yield different results.

Furthermore, references to the PDF master copy as well as the coordinates for the imprint have to be given in this FormData field. Resource IDs from the configuration repository are used for this purpose. Since the resource behind a resource ID does not change during the lifetime of the application (i.e. also in a changed version by changing the application configuration), a generation of the PDF will always yield the same results.

In the manner described, it is possible to generate PDFs or other intelligent documents as set forth in an exemplary embodiment of the present invention on the basis of a document data record. The document data record has, for example, the field contents described above.

After a suitable request has been called up, a document ID can be made available to the user via a URL and can be downloaded later in the form of a URL.

Example: http://pop.dhl.de/getPDF?documentId=abxkdl2fszo8afwg30y

A PDF can be generated directly on the basis of the document ID.

Since the document downloaded by the user only constitutes an empty form, a general PDF—optionally individual for each product (product key)—can be made available.

The servlet that delivers the PDF now merely has to rename the file name for the PDF in such a way that the document ID is contained in the file name.

Signing the document via ARES 306

The master copies are signed offline by the Acrobat Reader Extension Server during the development or preparation phase for a new product.

In the application, the document signed by the ARES 306 is then imported into the configuration repository.

iPDF Envelope, Sample Document and Postage Document

After the user has downloaded the generated PDF, the envelope of the PDF is displayed to him or her on the first page.

When the PDFs are downloaded in a suitable program, especially an Acrobat Reader, it is advantageous to carry out individual, several or all of the following checking steps:

compatibility of the reading program,

existence of an Internet connection,

validity of the document ID,

checking whether a print-out has already been made.

For the latter two checking steps, a service made available by the application is called via the SOAP interface of the Acrobat Reader, and this service reports back whether the transmitted document ID is present and/or is marked in the database as already having been printed before.

On the basis of the document ID, the form fields are downloaded via the SOAP interface by the POP's own server and then filled.

If no document ID could be ascertained, for example, since the user has renamed the PDF document, he or she is prompted via an Acrobat form field to enter the document ID. The document IDs are also included in the e-mail that is sent to the user.

Dummy codes are used for the barcodes for the sample printing. Only for the actual printing of the postage are the correct barcodes then briefly set by JavaScript.

### Employed PDF Reader Functionality (Technology)

The application uses the following JavaScript functions for the dynamic query to the license server from the Acrobat Reader:
app.viewerVersion: for checking the Reader version.
SOAP.*: to check for an Internet connection.
document.getField(“field name”).display=display.hidden/display.visible: for fading in and out “sample” overprints
document.print ({bUI: true, nStart: 1, nEnd: 1, bSilent: true, bAnnotation: true}) or document.print ({bUI: false, nStart: 1, nEnd: 1, bSilent: true, bAnnotation: true}) for directly printing the document without user interaction.
The actual PDFs to be printed are stored as annotation form fields (originally for visual feedback—e.g. when a button is pushed—in order to distinguish between the printed and non-printed states) and only switched to “visible” immediately before the printing. (Note: This approach might still be revised since, in a few scenarios, Acrobat Reader has problems printing out iPDFs.)
Barcode fields. The Acrobat Reader supports form fields that display an appropriate barcode for a value (as a rule, numerical value).
As an alternative, special fonts that are embedded in the document can be used for barcode fields.
For barcode types that Acrobat Reader does not support internally or through additional fonts, the barcode can be downloaded as a bitmap image via an external URL. For this purpose, a servlet service that generates and makes available the appropriate bitmap would have to be implemented in the application.

The described functionalities have a number of advantages:

Since the user does not download an individualized PDF, the PDFs only have to be signed per template/product via the ARES server.

As a result, an ARES 306 is not needed during the normal operation of the application.

It is advantageous to use the ARES 306 to insert new document types—especially to insert new products of a service provider—in order to sign the PDF in question once. Within the application, the signed document is then inserted as a resource. This installation of the ARES 306 can be effectuated on any computer. The interface for signing a document master copy can be configured in a simple manner.

The download of the PDF is a simple—virtually static—delivery of a file by the POP application. Any performance-relevant processes for the imprint can be dispensed with.

The PDFs can be generated with standard tools that are provided, for example, by the Adobe Company (with Acrobat Professional, the position of the form fields can be defined). The filling of the PDF form fields within the Acrobat Reader is a standard function.

Moreover, by dispensing with the necessity of signing each individual PDF, any error sources or performance bottlenecks that might occur here are also eliminated.

The elaborations selected above relate to PDF documents. However, it is likewise possible to use documents and programs that have comparable functions.

Documents as as referred to herein can preferably be displayed graphically. Depending on the area of application, they can be recorded manually or by machine. Moreover, depending on the area of application, it is also advantageous to provide for encryption.

An exemplary embodiment of the present invention also comprises documents that cannot be displayed graphically. Documents comprise

SmartLabels. SmartLabels are RFID identification means (transponders). They are suitable to be used for control processes in the processing or transporting of physical objects, especially of mailpieces or other goods that are to be transported.

The presented exemplary embodiments of the invention may be associated with a number of advantages:
It is possible to change the layout of the labels in a simple manner and, to a limited extent, even to adapt the functionality of the “intelligent PDFs” without having to launch the application anew (unlike the case with Stampit-Web), i.e. only the PDF master copy is replaced. As an alternative, it is possible to provide a new format master copy on the production systems via configuration update/admin-tool.
An increase in performance is achieved so that less server capacity is needed.
Data protection and security are increased, because no application-specific data, addresses, product information, are contained in the PDF—in the PDF master copy—even when the PDF is stored, after the data has been transferred via SOAP call for printing and/or after the printing has been initiated.
In especially preferred exemplary embodiments of the invention, it is possible to ascertain and, if applicable, also to log the configuration of user systems—especially of user computers that are being employed—if applicable, including the program versions employed.

In the manner described, the labels can be transmitted quickly, reliably and demand-controlled. In particular, it is possible to take into account requests from a shipping service provider that initially sends an article to the user in a first mailing and desires a systematic return of the articles in a second mailing.

According to an exemplary embodiment of the present invention, this is advantageously done in that a code is transmitted to a user via a first transmission route, in that the code is transmitted to a server via an operating unit located in the sphere of influence of the user, and in that the server executes a checking step for checking the code and, as a function of the result of the checking step, influences the production of the label.

The code is advantageously transmitted when a shipping event occurs, for example, when a mailpiece addressed to the user is dropped off, when a transportation or processing step of the mailpiece is carried out, or when the mailpiece is delivered to the user.

An exemplary embodiment of the present invention comprises various kinds of transmission of the code and allows the integration of various transmission modalities.

In order to ensure an especially high level of data security, the checking step is carried out in such a way that it comprises a validity check of the code.

In order to accelerate the processing, it is advantageous for a recipient address for the mailpiece to be ascertained, taking the code into account.

Moreover, it is advantageous to ascertain the sender address for the mailpiece, taking the code into account.

Moreover, it is advantageous for any additional information (such as, for example, the type and scope or the condition of the merchandise) to be ascertained taking the code into account.

Exemplary definitions of some of the terms used herein are set forth below:

User
Final user who uses the POP application in order to buy or use postage indicia or codes.

Application
The web application ParcelOnlinePostage.

Basic product
“Parcel”, “10-kg package”, “20-kg package”; is used, for example, for the grouping within the product selection.

Document ID
Unambiguous number such that a user can reference a postage indicium he or she has purchased.

Code
An instance of a code; can be identified via an unambiguous code.

Customer
This term is not used since it is ambiguous.

Shipping information system
A shipping information system is associated with every user session and this system prescribes some of the boundary conditions such as, for example, the currency.

Product
A combination of basic product and services; it is identified via a product key.

Product key
Unambiguous key for a basic product/services combination.

Service
Fee-based property of a product.

### LIST OF REFERENCE NUMERALS

10 transformation node
20 connector slot
30 external connector
40 transformation unit
50 internal connector
60 authorization and authentication unit
70 checking unit
80 controlling and reporting unit
90 data processing device
100 provider server
150 consolidator source (“transit marketplace”)
160 dissemination source (“area marketplace”)
200 user computer
301 PDF template
302 POP Web server
303 document data record
304 licensing information
305 intelligent document (for example, iPDF)
306 ARES

1-14. (canceled)

15. A method for the production of a label that can be applied onto a mailpiece, the method comprising:
transmitting a code to a user via a first transmission route, the code being transmitted to a server by an operating unit located in the sphere of influence of the user;
executing a checking step on the server to check the code; and
influencing the production of the label as a function of a result of the checking step.

16. The method recited in claim 15, comprising adding the code to a mailpiece addressed to the user.

17. The method recited in claim 15, wherein the code is transmitted to the user electronically.

18. The method recited in claim 15, wherein the code is transmitted to the user when a given event occurs.

19. The method recited in claim 18, wherein the event is a shipping event.

20. The method recited in claim 15, wherein the code is transmitted in response to a request.

21. The method recited in claim 15, wherein the operating unit comprises a computer.

22. The method recited in claim 15, wherein the operating unit comprises a mobile user unit.

23. The method recited in claim 15, wherein the checking step comprises a validity check of the code.

24. The method recited in claim 15, comprising ascertaining a recipient address for the mailpiece taking the code into account.

25. The method recited in claim 15, comprising ascertaining a sender address for the mailpiece taking the code into account.

26. The method recited in claim 15, comprising:
ascertaining information about a product that is to be returned with the mailpiece; and
applying the information onto a return label.

27. A tangible, machine-readable medium that stores machine-readable instructions that are executable by a computer to produce a label that can be applied onto a mailpiece, the tangible, machine-readable medium comprising:
machine-readable instructions that, when executed by a computer, transmit a code to a user via a first transmission route, the code being transmitted to a server by an operating unit located in the sphere of influence of the user;
machine-readable instructions that, when executed by a computer, execute a checking step on the server to check the code; and
machine-readable instructions that, when executed by a computer, influence the production of the label as a function of a result of the checking step.

28. A device for the production of a label that can be applied onto a mailpiece, the device comprising:
means for transmitting a code to a user via a first transmission route, the code being transmitted to a server by an operating unit located in the sphere of influence of the user;
means for executing a checking step on the server to check the code; and
means for influencing the production of the label as a function of a result of the checking step.
